(19) United States
(12) Patent Application Publication
(10) Pub. No.: US 2007/0273953 A1
(43) Pub. Date: Nov. 29, 2007

(54) Method of reducing speckles and an apparatus therefor

(75) Inventors: Sun-Lyeong Hwang, Suwon-si (KR); Jung-Kee Lee, Hwaseong-si (KR); Du-Chang Heo, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/649,058

(22) Filed: Jan. 3, 2007

(30) Foreign Application Priority Data
May 29, 2006 (KR) 48079/2006

(51) Int. Cl. G02F 1/01

(52) U.S. Cl. 359/279

(57) ABSTRACT

Disclosed is a method of reducing speckles appearing in a laser beam. The method includes the steps of splitting the laser beam into two polarized light modes perpendicular to each other; modifying the phase of at least one of the two polarized light modes, and combining the two polarized light modes into a single laser beam outputted. The method is performed by using an apparatus that includes a light source to generate a laser beam, a polarization split filter to split the laser beam into two polarized light modes perpendicular to each other and then re-combine said two polarized light modes, and a multi-angle reflection mirror to reflect one of the two polarized light modes to the polarization split filter, wherein the polarization split filter is inserted in the multi-angle reflection mirror.

### CLAIM OF PRIORITY

This application claims priority under 35 U.S.C. §119 to an application entitled “Method of Reducing Speckles and an Apparatus therefore,” filed in the Korean Intellectual Property Office on May 29, 2006 and assigned Serial No. 2006-48079, the contents of which are incorporated herein by reference.

### BACKGROUND OF THE INVENTION

1. Field of the Invention

The present invention relates to a laser beam source, and more particularly to a method of reducing speckles appearing in a laser beam.

2. Description of the Related Art

The coherence of a laser beam enables it to be widely used for varieties of instruments such as image pickup apparatus, projector and measuring device. On the contrary, if a rough surface is irradiated with a laser beam, the coherence causes scattering and interference of the laser beam. This, in turn, results in a pattern of speckles. Such a speckle pattern of a laser beam naturally contains the information on the irradiated surface, such as distortion. This information can be periodically recorded and may then be used for measuring a variety of characteristics, for example, dislocation or distortion, velocity, vibration, and duality of an object, and MTF (Modulation Transfer Function) of an optical system and a light sensitive material, and so on.

If the laser beam is applied to an optical imaging system, the speckle pattern causes image blurring or resolution degrading. This degradation needs to be eliminated. In order to eliminate the speckle pattern, the use of a ground glass for making forced scattering or vibration of the laser beam has been proposed. Such a conventional method requires a bulky device for eliminating the speckle pattern, which is unsuitable for current miniaturized imaging systems.

### SUMMARY OF THE INVENTION

It is an object of the present invention to provide a compact apparatus for reducing the speckle patterns occurring in the laser beam, and a laser optical module using it.

According to the principles of the present invention, a method of reducing speckles appearing in a laser beam is proposed. The method includes the steps of splitting the laser beam into two polarized light modes perpendicular to each other; modifying the phase of at least one of the two polarized light modes; and combining the two polarized light modes into a single laser beam.

According to the principles of the present invention, an apparatus for reducing speckles appearing in a laser beam is proposed. The apparatus includes a light source to generate a laser beam; a polarization split filter to split the laser beam into two polarized light modes perpendicular to each other and then re-combine said two polarized light modes; and a multi-angle reflection mirror to reflect one of the two polarized light modes to the polarization split filter, wherein the polarization split filter is inserted in the multi-angle reflection mirror.

### BRIEF DESCRIPTION OF THE DRAWINGS

The present invention will become more apparent from the following detailed description when taken in conjunction with the accompanying drawing in which:

FIG. 1 is a schematic diagram illustrating an apparatus for reducing the speckles occurring in a laser beam according to the present invention;

FIG. 2 is a plane exploded view of a multi-angle reflection mirror as shown in FIG. 1; and

FIG. 3 is a side view of a multi-angle reflection mirror as shown in FIG. 1.

### DETAILED DESCRIPTION OF THE INVENTION

Now, embodiments of the present invention will be described herein below with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

According to the principles of the present invention two polarized light modes constituting a laser beam are separated to modify the phase of one of the two modes. These two polarized light modes are then combined having different phases so as to generate the resultant laser beam without speckles. The phase modification is achieved by employing a plurality of reflection mirrors to make the two polarized light modes have different beam paths.

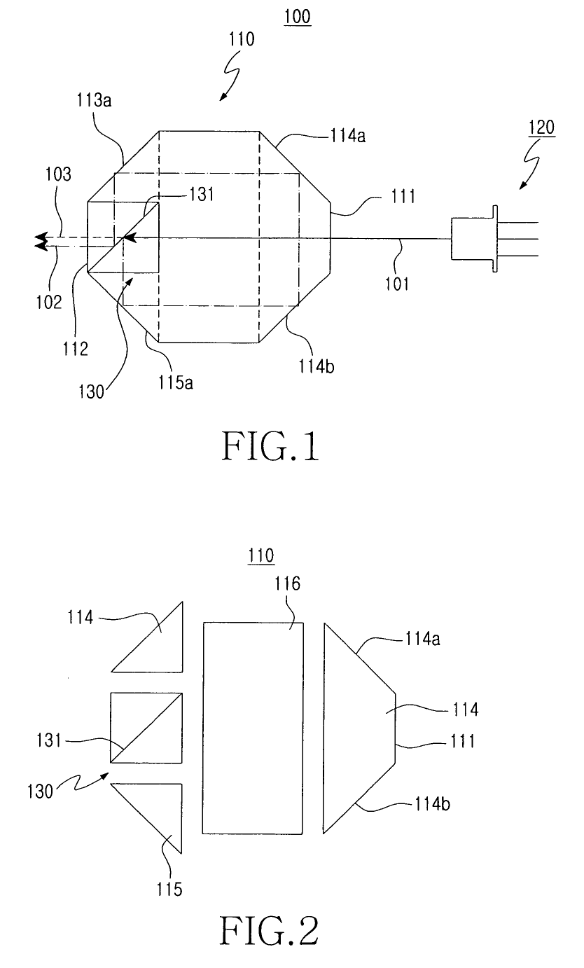

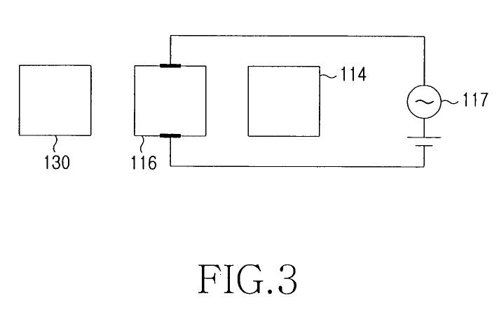

Referring to FIGS. 1 and 3, the apparatus 100 for reducing the speckles occurring in a laser beam according to the present invention, includes (1) a light source 120 for generating a laser beam, (2) a polarization split filter 130 with an output end for splitting the laser beam into two polarized light modes perpendicular to each other and then combining them to generate the resultant, and (3) a multi-angle reflection mirror 110 for reflecting one of the two polarized light modes so as to return to the polarization split filter 130. The polarization split filter is inserted in the multi-angle reflection mirror 110 with the output end exposed to the outside.

The polarization split filter 130 includes a polarization filter 131, which forms an oblique angle to the direction of the laser beam 101 incident on the multi-angle reflection mirror 110. The polarization filter 131 may be a multilayer thin film. The polarization filter 131 splits the laser beam 101 into the two polarized light modes 102 and 103, so that it may pass one mode 103 and reflect the other 102. Namely, it splits the laser beam 101 into TE mode 102 reflected by the multi-angle reflection mirror 110 and TM mode 103 transmitted. The TE mode 102 is reflected by the multi-angle reflection mirror 110 returning to the polarization split filter 130. On the contrary, the polarization split filter 130 may transmit the TE mode 102, and reflect the TM mode 103.

The multi-angle reflection mirror 110 includes first to fourth optical devices 113, 114, 115, 116. The multi-angle reflection mirror 110 may be formed by assembling separate elements or integrated as a whole. The first and second optical devices 113 and 115 are symmetrically mounted on two sides of the polarization split filter 130. They have their respective reflectors 113a and 115a to reflect the one polarized light mode 102 reflected on the polarization filter 131. Namely, the first optical device 115 reflects the TE mode 102 split by the polarization split filter 130 toward the third optical device 114, which in turn reflects the TE mode 102 toward the second optical device 113, which in turn reflects the TE mode 102 toward the polarization split filter 130. Finally the polarization split filter 130 combines the TM and TE polarization light modes, which have different phases through the first to fourth optical devices 113, 114, 115 and 116, to generate the resultant laser beam outside the speckle reduction apparatus 100.

The third optical device has an input end 111 to receive the incident laser beam 101 from the light source 120 and reflectors 114a and 114b to reflect the one polarized light mode toward the second optical device 113. The fourth optical device 116 is arranged between the first and second optical devices 113 and 115 and the third optical device 114, and the fourth optical device 116 may include a piezoelectric element. As shown in FIG. 3, it modifies the phase of the incident polarization light mode by an externally applied voltage.

The phase modification is achieved by two procedures. One procedure subjects one of the two polarization light modes split by the polarization split filter 130 to multiple reflections through the multi-angle reflection mirror 110. This causes path difference between them. The other procedure has the fourth optical device 116 apply a vibration generated by an externally applied voltage to the polarization light mode passing it. The phase modification causes a slight wavelength difference Δλ between the two polarization light modes. The combination of the polarization light modes having different phases diminishes the coherence of the laser beam so as to effect about \sqrt{2} times speckle reduction. The elimination of the speckles may be achieved by scattering using a scattering mirror, represented by the following Equation 1.

$$R Ω = {[ \frac{{Ω}_{proj}}{{Ω}_{det}} ]}^{1 / 2} \qquad Equation 1$$

wherein RΩ represents the speckle, Ωₚᵣₒⱼ the scattered degree of the light beam reflected on an object (screen), and Ω_{det} the scattered degree of the light beam generated from the light source.

The method and apparatus according to the present invention may be understood from wavelength variation. The symbol R_{λ} in the following Equations 2 and 3 represents the speckles caused by wavelength variation.

R_{λ}=[N_{λ}]^{1/2} Equation 2

wherein N_{λ} represents the mode number of the wavelengths generated by the light source. Namely, the speckles appear according to the mode number of the wavelengths generated by the laser source.

$${R}_{λ} = {[ \frac{Δλ}{δλ} ]}^{1 / 2} \qquad Equation 3$$

wherein Δλ represents the spectral linewidth of the light beam generated by the laser source, and δλ the wavelength of the light beam.

The following Equation 4 represents the relationship between the phase variation and the spectral linewidth of the light beam. Namely, the wavelength variations shown by Equation 3 may be deduced from the phase variation of the light beam as shown by the following Equation 4.

$$Δλ - \frac{{λ}^{2}}{c Δτ} \qquad Equation 4$$

wherein Δλ represents the spectral linewidth of the light beam generated by the laser source, Δτ the time difference according to the spectral linewidth, and c a constant compensating for the relationship between λ and Δτ.

Using the respective variations of the above equations, the speckle factor may be minimized as shown by the following Equation 5.

R−RΩ×R_{λ}×R_{σ}=2R_{λ}[Ωₚᵣₒⱼ×Ω_{det}]^{1/2} Equation 5

Thus, the apparatus and laser beam module according to the present invention have a simple and compact structure for reducing the speckle pattern of a laser beam. The invention also minimizes additional problems such as resolution degradation. In addition, the invention provides the multi-angle reflection mirror with piezoelectric element for adjusting the phase of the laser beam as desired. While the invention has been shown and described with reference to a certain preferred embodiment thereof, it will be understood by those skilled in the art that various changes in form and details may be made therein without departing from the spirit and scope of the invention.

What is claimed is:

1. A method of reducing speckles appearing in a laser beam, the method comprising the steps of:
splitting said laser beam into two polarized light modes perpendicular to each other;
modifying the phase of at least one of said two polarized light modes; and
combining the two modified polarized light modes into a single laser beam.

2. The method as defined in claim 1, wherein the modifying step includes modifying the phase of one or both of said two polarized light modes such that said two polarized light modes have different phases.

3. The method as defined in claim 1, wherein the modifying step includes reflecting one of said two polarized light modes.

4. An apparatus for reducing speckles appearing in a laser beam, comprising:
a light source to generate a laser beam;
a polarization split filter to split said laser beam into two polarized light modes perpendicular to each other and then re-combine said two polarized light modes; and
a multi-angle reflection mirror to reflect one of said two polarized light modes to said polarization split filter, wherein said polarization split filter is inserted in said multi-angle reflection mirror.

5. The apparatus as defined in claim 4, wherein said multi-angle reflection mirror includes:
a first and a second optical device each having a reflector symmetrically mounted on two sides of said polarization split filter to reflect said one polarized light mode;
a third optical device having an input end for receiving the incident laser beam from said light source and reflectors for reflecting said one polarized light mode toward the second optical device; and
a fourth optical device arranged between the first and second optical devices and the third optical device.

6. The apparatus as defined in claim 5, wherein the first to fourth optical devices are formed of separate elements that are assembled or integrated as a whole.

7. The apparatus as defined in claim 5, wherein the fourth optical device includes a piezoelectric element.

8. The apparatus as defined in claim 4, wherein said polarization split filter includes a multilayer thin film polarization filter.
